(19) United States
(12) Patent Application Publication
(10) Pub. No.: US 2004/0023619 A1
(43) Pub. Date: Feb. 5, 2004

(54) Transmission-and-receiving switching circuit not allowing superfluous signals to be input or output

(75) Inventor: Toru Izumiyama, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/611,587

(22) Filed: Jun. 30, 2003

(30) Foreign Application Priority Data
Jul. 10, 2002 (JP) 2002-200798

(51) Int. Cl. H04B 1/02

(52) U.S. Cl. 455/91

(57) ABSTRACT

A transmission-and-receiving switching circuit includes a signal input-and-output end to which an antenna is connected; a transmission circuit connected to the signal input-and-output end through a first switching diode; a receiving circuit connected to the signal input-and-output end through a second switching diode; and first and second inductor elements for feeding bias voltages to the first switching diode and the second switching diode respectively. A first resonant circuit contains a first capacitor element and the first inductor element for at least series resonating between the first switching diode and ground. The series resonant frequency of the first resonant circuit is about equal to a frequency of a signal other than the transmission signal output from the transmission circuit.

### BACKGROUND OF THE INVENTION

1. Field of the Invention

The present invention relates to transmission-and-receiving switching circuits which connect an antenna to a transmission circuit or to a receiving circuit of a TDMA method transmission-and-receiving unit and others used in portable telephones, radio LANs, and others.

2. Description of the Related Art

FIG. 5 shows a conventional transmission-and-receiving switching circuit. A switch circuit 31 is formed of first to fourth switching diodes 31a to 31d connected in a ring shape so as to have the same PN-junction direction. The connection point of the first switching diode 31a and the second switching diode 31b adjacent to each other serves as a first signal input-and-output end 32, and the connection point of the third switching diode 31c and the fourth switching diode 31d adjacent to each other serves as a second signal input-and-output end 33. One antenna (antenna A, not shown) is connected to the first signal input-and-output end 32, and the other antenna (antenna B, not shown) is connected to the second signal input-and-output end 33. One antenna is required for usual transmission and receiving, but two antennas are used in this case to allow space diversity receiving.

A transmission circuit 34 and a receiving circuit 36 to which the antenna A or the antenna B is connected by the switch circuit 31, each include an oscillator for outputting a local oscillation signal for frequency conversion.

The transmission circuit 34 is connected to a transmission end 35 which is the connection point of the first switching diode 31a and the third switching diode 31c, and the receiving circuit 36 is connected to a receiving end 37 which is the connection point of the second switching diode 31b and the fourth switching diode 31d.

As a result, the transmission circuit 34 is connected to the first signal input-and-output end 32 through the first switching diode 31a, and is also connected to the second signal input-and-output end 33 through the third switching diode 31c. The receiving circuit 36 is connected to the first signal input-and-output end 32 through the second switching diode 31b, and is also connected to the second signal input-and-output end 33 through the fourth switching diode 31d.

An inductor element 39 and a resistor 40 connected to each other in series and used for feeding are connected between the first signal input-and-output end 32 and a first switching terminal 38, and an inductor element 41 and a resistor 42 connected to each other in series and used for feeding are also connected between the second signal input-and-output end 33 and the first switching terminal 38.

In the same way, an inductor element 44 and a resistor 45 connected to each other in series and used for feeding are connected between the transmission end 35 and a second switching terminal 43, and an inductor element 46 and a resistor 47 connected to each other in series and used for feeding are connected between the receiving end 37 and the second switching terminal 43.

The resistors 40, 42, 45, and 47 determine the magnitude of current flowing into the switching diodes 31a to 31d. The inductor elements 39, 41, 44, and 46 play a role as choke inductors, and prevent the impedance at the first and second signal input-and-output ends 32 and 33, the transmission end 35, and the receiving end 37 from decreasing.

With the above-described structure, a low switching voltage is applied to one of the first switching terminal 38 and the second switching terminal 43, and a high switching voltage is applied to the other. As a result, the first switching diode 31a and the fourth switching diode 31d are both turned on or off, and the second switching diode 31b and the third switching diode 31c are both turned on or off. In this case, when the first switching diode 31a and the fourth switching diode 31d are both turned on, the second switching diode 31b and the third switching diode 31c are both turned off. Conversely, when the first switching diode 31a and the fourth switching diode 31d are both turned off, the second switching diode 31b and the third switching diode 31c are both turned on.

An operation will be described next, performed when the first signal input-and-output end 32 and the antenna A connected thereto are used. In a transmission mode, the first switching terminal 38 is set high and the second switching terminal 43 is set low. Then, the first switching diode 31a (fourth switching diode 31d) is turned on, and the second switching diode 31b (third switching diode 31c) is turned off. In this mode, of course, the transmission circuit 34 is in an operation state, and the receiving circuit 36 is in a non-operation state. Therefore, a transmission signal is output to the antenna A through the first switching diode 31a. In this state, the inductance of the inductors 39 and 44 for feeding the switching diode 31a is set sufficiently high to prevent the loss of the transmission signal.

In a receiving mode, the first switching terminal 38 is set low and the second switching terminal 43 is set high. Then, the first switching diode 31a (fourth switching diode 31d) is turned off, and the second switching diode 31b (third switching diode 31c) is turned on. In this mode, of course, the receiving circuit 36 is in an operation state, and the transmission circuit 34 is in a non-operation state. Therefore, a receiving signal is input from the antenna A through the second switching diode 31b to the receiving circuit 36. In this state, the inductance of the inductors 39 and 46 for feeding the switching diode 31b is set sufficiently high to prevent the loss of the receiving signal.

When the antenna B is used, the first switching terminal 38 is set low and the second switching terminal 43 is set high to make the receiving circuit 36 to be in the non-operation state in the transmission mode. In the receiving mode, the first switching terminal 38 is set high and the second switching terminal 43 is set low to make the transmission circuit 34 to be in the non-operation state.

With the above-described structure, the local oscillation signal generated in the transmission circuit is output to the antenna A together with the transmission signal during transmission, and interferes with other communication units. In the same way, when the antenna A receives a signal other than the intended receiving signal during receiving, the signal is also input to the receiving circuit to interfere with the receiving circuit. In addition, the local oscillation signal generated in the receiving circuit is also output to the antenna A.

### SUMMARY OF THE INVENTION

An object of the present invention is to provide a simple structure which does not output superfluous signals (signals other than the intended transmission signal) and which does not receive superfluous signals (signals other than the intended receiving signal) at the receiving circuit. Additionally, the simple structure decreases the amount of interference between the structure and other communication units.

In one embodiment, a transmission-and-receiving switching circuit includes a signal input-and-output end to which an antenna is connected; a transmission circuit connected to the signal input-and-output end through a first switching diode; a receiving circuit connected to the signal input-and-output end through a second switching diode; and inductor elements for feeding bias voltages to the first switching diode and the second switching diode. The transmission and receiving circuits are configured to output a transmission signal and to receive a receiving signal, respectively. The first switching diode and the second switching diode are switched to opposite operating states opposite (on or off) by the bias voltages. A first resonant circuit contains a first capacitor element coupled with the inductor element for feeding the first switching diode. The first resonant circuit at least series resonates between the first switching diode and the ground. The series resonant frequency of the first resonant circuit is about equal to the frequency of a signal other than the transmission signal.

The series resonant frequency may be about equal to the frequency of a local oscillation signal in the transmission circuit.

The first resonant circuit may be provided between ground and the connection point of the first switching diode and the transmission circuit.

The transmission-and-receiving switching circuit may be configured such that the first resonant circuit is formed of a series-parallel resonant circuit. The parallel resonant frequency of the series-parallel resonant circuit is about equal to the frequency of the transmission signal.

The first capacitor element and the inductor element for feeding the first switching diode may be formed of lumped-constant-type circuit components.

The transmission-and-receiving switching circuit may be configured such that a second resonant circuit for at least series resonating between the second switching diode and the ground contains a second capacitor element together with the inductor element for feeding the second switching diode. The series resonant frequency of the second resonant circuit is about equal to the frequency of a signal other than the receiving signal input to the receiving circuit.

The second resonant circuit may be provided between ground and the connection point of the second switching diode and the receiving circuit.

The transmission-and-receiving switching circuit may be configured such that the second resonant circuit is formed of a second series-parallel resonant circuit. The parallel resonant frequency of the second series-parallel resonant circuit is about equal to the frequency of the receiving signal.

The second capacitor element and the inductor element for feeding the second switching diode may be formed of lumped-constant-type circuit components. In another embodiment, the transmission-and-receiving switching circuit comprises a pair of signal input-and-output ends and an antenna connected to one of the pair of signal input-and-output ends. A transmission circuit is connected to the one of the pair of signal input-and-output ends through a first switching diode and to the other of the pair of signal input-and-output ends through a second switching diode. The transmission circuit is configured to output a transmission signal of a transmission frequency. A receiving circuit is connected to the one of the pair of signal input-and-output ends through a third switching diode and to the other of the pair of signal input-and-output ends through a fourth switching diode. The receiving circuit is configured to receive a receiving signal of a receiving frequency. An inductor element is connected between each switching diode and each of a pair of voltage feeding points. A first resonant circuit contains a first capacitor element connected between ground and a first of the inductor elements and a second resonant circuit that contains a second capacitor element connected between ground and a second of the inductor elements. The first and fourth switching diodes operate in opposite operating states from the second and third switching diodes. A series resonant frequency of the first resonant circuit is about equal to a frequency of a signal other than one of the receiving and transmission signals.

The series resonant frequency may be about equal to a frequency of a local oscillation signal in one of the receiving and transmission circuits.

A first connection point may connect the first switching diode, the second switching diodes and the transmission circuit, and the first resonant circuit provided between ground and the first connection point. In this case, a second connection point may connect the third switching diode, the fourth switching diode and the receiving circuit, and the second resonant circuit provided between ground and the second connection point or a second connection point may connect the first switching diode, the third switching diode and a first of the pair of signal input-and-output ends, and the second resonant circuit provided between ground and the second connection point.

The first resonant circuit may be formed of a series-parallel resonant circuit, and a parallel resonant frequency of the series-parallel resonant circuit is about equal to the transmission frequency. Similarly, the first and second resonant circuits may each comprise a series-parallel resonant circuit with a parallel resonant frequency of about equal to the receiving frequency and the transmission frequency, respectively.

A first connection point may connect the third switching diode, the fourth switching diodes and the receiving circuit, and the first resonant circuit is provided between ground and the first connection point. In this case, a second connection point may connect the first switching diode, the third switching diode and a first of the pair of signal input-and-output ends, and the second resonant circuit is provided between ground and the second connection point or the first resonant circuit may be formed of a series-parallel resonant circuit, and a parallel resonant frequency of the series-parallel resonant circuit is about equal to the receiving frequency.

In another embodiment, a method of receiving and transmitting signals comprises transmitting a transmission signal to a signal input-and-output end through a first switching diode, receiving a receiving signal from the signal input-and-output end through a second switching diode, feeding bias voltages to the first switching diode and the second switching diode, switching the first switching diode and the second switching diode to opposing operating states via the bias voltages, and coupling a first series resonant circuit between the first switching diode and ground, the first series resonant circuit having a first series resonant frequency about equal to a frequency of a signal other than the transmission signal.

The method may further comprise forming the first series resonant circuit from an inductor in series with a first capacitor, connecting the first capacitor to ground and the inductor to the first switching diode. In this case, the method may further comprise forming a parallel resonant circuit with the first series resonant circuit by connecting a second capacitor in parallel with the inductor, the parallel resonant circuit having a frequency of about equal to a frequency of the transmission signal.

The method may comprise reducing local oscillation signals when transmitting the transmission signal by providing that the first series resonant frequency is about equal to a frequency of the local oscillation signals.

The method may comprise coupling a second resonant circuit between the second switching diode and ground, a second series resonant frequency of the second resonant circuit having a second resonance frequency of about equal to a frequency of a signal other than the receiving signal. In this case, the method may further comprise forming the second series resonant circuit from an inductor in series with a first capacitor, connecting the first capacitor to ground and the inductor to the second switching diode and even further comprise forming a parallel resonant circuit with the second series resonant circuit by connecting a second capacitor in parallel with the inductor, the parallel resonant circuit having a frequency of about equal to a frequency of the receiving signal.

### BRIEF DESCRIPTION OF THE DRAWINGS

FIG. 1 is a circuit diagram showing the structure of a transmission-and-receiving switching circuit according to the present invention.

FIG. 2 is a circuit diagram showing the structure of another transmission-and-receiving switching circuit according to the present invention.

FIG. 3 is a circuit diagram showing the structure of still another transmission-and-receiving switching circuit according to the present invention.

FIG. 4 is a circuit diagram showing the structure of yet another transmission-and-receiving switching circuit according to the present invention.

FIG. 5 is a circuit diagram showing the structure of a conventional transmission-and-receiving switching circuit.

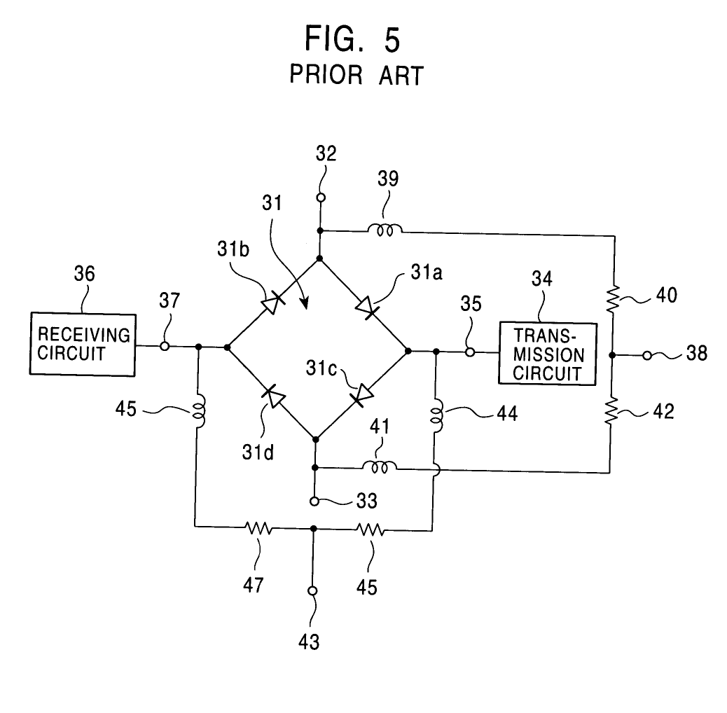

### DESCRIPTION OF THE PREFERRED EMBODIMENTS

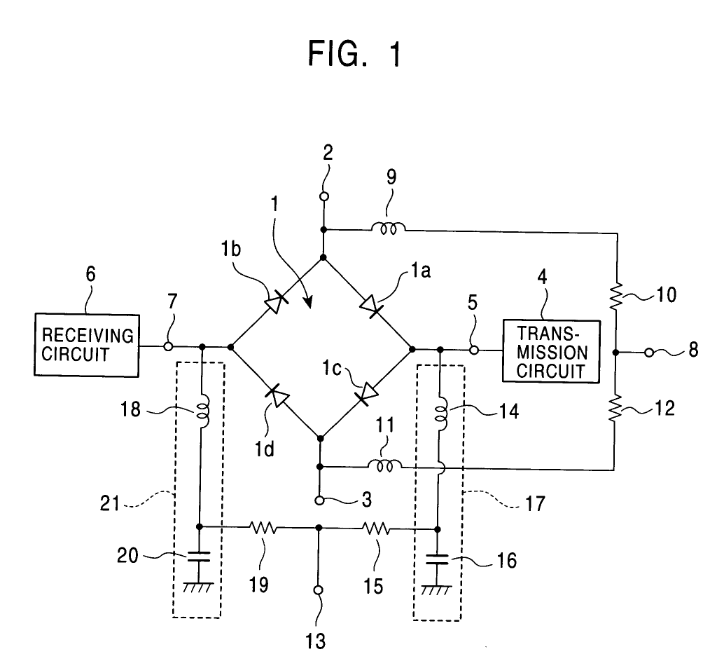

FIG. 1 to FIG. 4 show transmission-and-receiving switching circuits according to the present invention. In FIG. 1, a switch circuit 1 is formed of first to fourth switching diodes 1a to 1d connected in a ring shape so as to have the same PN-junction direction. The connection point of the first switching diode 1a and the second switching diode 1b adjacent to each other serves as a first signal input-and-output end 2, and the connection point of the third switching diode 1c and the fourth switching diode 1d adjacent to each other serves as a second signal input-and-output end 3. One antenna (antenna A, not shown) is connected to the first signal input-and-output end 2, and the other antenna (antenna B, not shown) is connected to the second signal input-and-output end 3. One antenna is required for usual transmission and receiving, but two antennas are used in this case to allow space diversity receiving.

A transmission circuit 4 and a receiving circuit 6 to which the antenna A or the antenna B is connected by the switch circuit 1, each include an oscillator for outputting a local oscillation signal for frequency conversion.

The transmission circuit 4 is connected to a transmission end 5 which is the connection point of the first switching diode 1a and the third switching diode 1c, and the receiving circuit 6 is connected to a receiving end 7 which is the connection point of the second switching diode 1b and the fourth switching diode 1d.

As a result, the transmission circuit 4 is connected to the first signal input-and-output end 2 through the first switching diode 1a, and is also connected to the second signal input-and-output end 3 through the third switching diode 1c. The receiving circuit 6 is connected to the first signal input-and-output end 2 through the second switching diode 1b, and is also connected to the second signal input-and-output end 3 through the fourth switching diode 1d.

An inductor element 9 and a resistor 10 connected to each other in series and used for feeding are connected between the first signal input-and-output end 2 and a first switching terminal 8, and an inductor element 11 and a resistor 12 connected to each other in series and used for feeding are also connected between the second signal input-and-output end 3 and the first switching terminal 8.

In the same way, an inductor element 14 and a resistor 15 connected to each other in series and used for feeding are connected between the transmission end 5 and a second switching terminal 13. The inductor element 14 is connected to the transmission end 5, and the resistor 15 is connected to the second switching terminal 13. The connection point of the inductor element 14 and the resistor 15 is grounded by a first capacitor element 16 in a high-frequency manner. The inductor element 14 and the first capacitor element 16 are formed of lumped-constant-type circuit components. Therefore, the inductor element 14 and the first capacitor element 16 constitute a first resonant circuit 17 which series resonates at only one frequency. This series resonant frequency is set about equal, for example, to the local oscillation frequency of the oscillator in the transmission circuit 4. About equal to is within 5-10% of the value stated.

An inductor element 18 and a resistor 19 connected to each other in series and used for feeding are connected between the receiving end 7 and the second switching terminal 13. The inductor element 18 is connected to the receiving end 7, and the resistor 19 is connected to the second switching terminal 13. The connection point of the inductor element 18 and the resistor 19 is grounded by a second capacitor element 20 in a high-frequency manner. The inductor element 18 and the second capacitor element 20 are formed of lumped-constant-type circuit components. Therefore, the inductor element 18 and the second capacitor element 20 constitute a second resonant circuit 21 which series resonates at only one frequency. This series resonant frequency is set about equal, for example, to the local oscillation frequency of the oscillator in the receiving circuit 6 or to the frequency of a signal other than the receiving signal received by the antenna.

The resistors 10, 12, 15, and 19 determine the magnitude of current flowing into the switching diodes 1a to 1d. The inductor elements 9 and 11 play a role as choke inductors, and prevent the impedance at the first and second signal input-and-output ends 2 and 3 from decreasing.

The inductor elements 14 and 18 constitute the resonant circuits 17 and 21 while they serve as high-impedance elements at the transmission frequency and the receiving frequency to prevent the transmission signal and the receiving signal from attenuating.

With the above-described structure, a low switching voltage is applied to one of the first switching terminal 8 and the second switching terminal 13, and a high switching voltage is applied to the other terminal. As a result, the first switching diode 1a and the fourth switching diode 1d are both turned on or off, and the second switching diode 1b and the third switching diode 1c are both turned on or off. In this case, when the first switching diode 1a and the fourth switching diode 1d are both turned on, the second switching diode 1b and the third switching diode 1c are both turned off. Conversely, when the first switching diode 1a and the fourth switching diode id are both turned off, the second switching diode 1b and the third switching diode 1c are both turned on.

An operation will be described next, performed when the first signal input-and-output end 2 and the antenna A connected thereto are used. In a transmission mode, the first switching terminal 8 is set high and the second switching terminal 13 is set low. Then, the first switching diode 1a (fourth switching diode 1d) is turned on, and the second switching diode 1b (third switching diode 1c) is turned off. In this mode, of course, the transmission circuit 4 is in an operation state, and the receiving circuit 6 is in a non-operation state. Therefore, a transmission signal is output to the antenna A through the first switching diode 1a. In this state, the inductance of the inductors 9 and 14 for feeding the switching diode 1a is set sufficiently high to prevent the loss of the transmission signal. In addition, even when the local oscillation signal is output from the transmission circuit 4, it attenuates at the first resonant circuit 17, and is not output to the antenna A. The series resonant frequency of the first resonant circuit 17 may be set to a signal frequency other then the local oscillation frequency.

In a receiving mode, the first switching terminal 8 is set low and the second switching terminal 13 is set high. Then, the first switching diode 1a (fourth switching diode 1d) is turned off, and the second switching diode 1b (third switching diode 1c) is turned on. In this mode, of course, the receiving circuit 6 is in an operation state, and the transmission circuit 4 is in a non-operation state. Therefore, a receiving signal is input from the antenna A through the second switching diode 1b to the receiving circuit 6. In this state, the inductance of the inductors 9 and 18 for feeding the second switching diode 1b is set sufficiently high to prevent the loss of the receiving signal. When the series resonant frequency of the second resonant circuit 21 is set to the frequency of a signal other than the receiving signal, for example, to the frequency of the local oscillation signal generated by the receiving circuit 6, the signal is not output to the antenna A. Conversely, when there is the possibility of receiving a superfluous signal by the antenna A, if the resonant frequency of the second resonant circuit 21 is set to the frequency of that signal, the signal is prevented from entering the receiving circuit 6.

When the antenna B is used, the first switching terminal 8 is set low and the second switching terminal 13 is set high to make the receiving circuit 6 to be in the non-operation state in the transmission mode. In the receiving mode, the first switching terminal 8 is set high and the second switching terminal 13 is set low to make the transmission circuit 4 to be in the non-operation state.

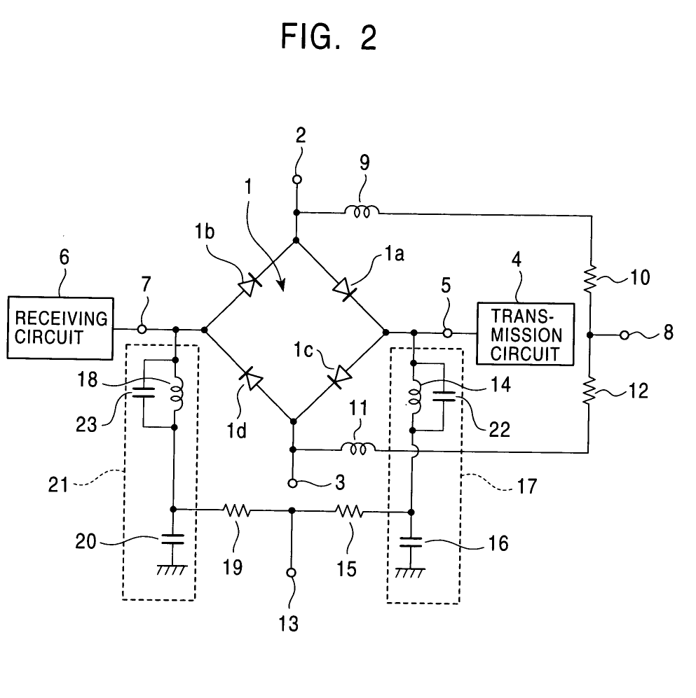

FIG. 2 shows another example structure according to the present invention. In this structure, a first resonant circuit 17 and a second resonant circuit 21 are formed of series-parallel resonant circuits. To structure a series-parallel resonant circuit, in the first resonant circuit 17, an inductor element 14 and a third capacitor element 22 are connected in parallel, and the parallel resonant frequency determined by the inductor element 14 and the third capacitor element 22 is set about equal to the transmission frequency. In the second resonant circuit 21, an inductor element 18 and a fourth capacitor element 23 are connected in parallel. The parallel resonant frequency determined by the inductor element 18 and the third capacitor element 23 is set about equal to the receiving frequency. The other portions have the same structure as those shown in FIG. 1.

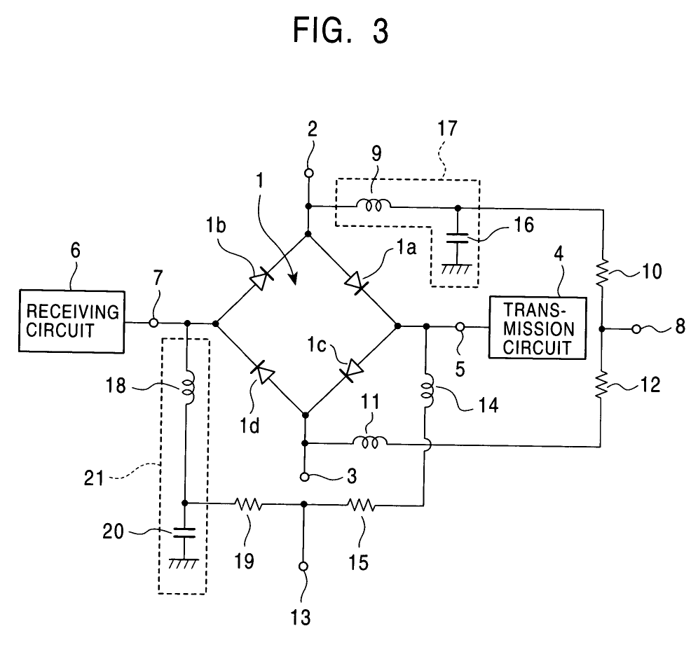

FIG. 3 shows still another example structure according to the present invention. In this structure, a first resonant circuit 17 is formed by using an inductor element 9 for feeding a first switching diode 1a at a first signal input-and-output end 2 side. To this end, the connection point of the inductor element 9 and a resistor 10 is grounded by a first capacitor element 16 in a high-frequency manner, and the series resonant frequency of the inductor element 9 and the first capacitor element 16 is set, for example, about equal to the local oscillation frequency of a transmission circuit 4.

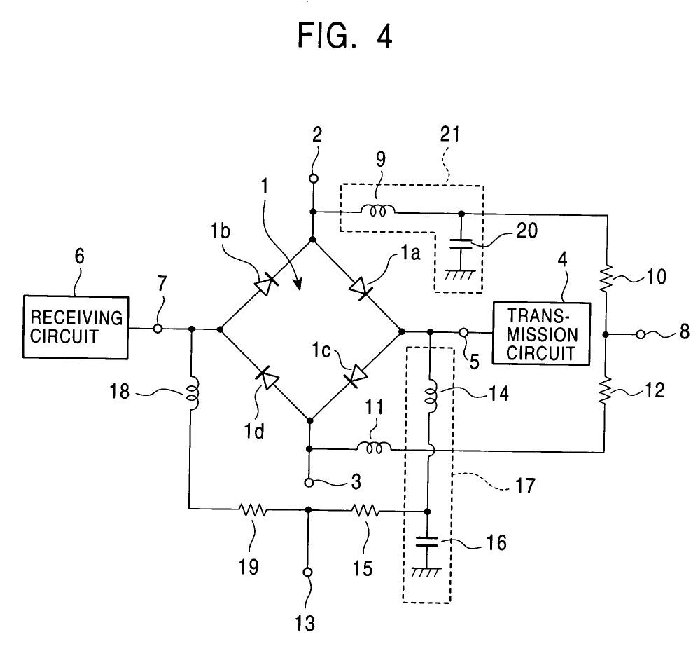

Further, FIG. 4 shows another structure. A second resonant circuit 21 is formed by using an inductor element 9 (also serving as an inductor element for feeding a first switching diode 1a) for feeding at a first signal input-and-output end 2 side a second switching diode 1b. To this end, the connection point of the inductor element 9 and a resistor 10 is grounded by a second capacitor element 20 in a high-frequency manner, and the series resonant frequency of the inductor element 9 and the second capacitor element 20 is set, for example, equal to the local oscillation frequency of a receiving circuit 6 or to the frequency of a signal other than the receiving signal which arrives at the antenna A.

As described above, since the first capacitor element is provided which constitutes the first resonant circuit for at least series resonating between the first switching diode and the ground together with the inductor element for feeding the first switching diode, and the series resonant frequency of the first resonant circuit is set about equal to the frequency of a signal other than the transmission signal output from the transmission circuit, the transmission signal is not attenuated, and a signal which causes interference is not output to the antenna.

Since the series resonant frequency is set about equal to the frequency of the local oscillation signal in the transmission circuit, the local oscillation signal is not output to the antenna, and therefore, interference is not provided to other communication units.

Since the first resonant circuit is provided between the connection point of the first switching diode and the transmission circuit, and the ground, the first resonant circuit does not affect the receiving circuit during reception of signals.

Since the first resonant circuit is formed of a series-parallel resonant circuit, and the parallel resonant frequency of the series-parallel resonant circuit is set about equal to the frequency of the transmission signal, the series-parallel resonant circuit does not attenuate the transmission signal.

Since the first capacitor element and the inductor element for feeding the first switching diode are formed of lumped-constant-type circuit components, only one series resonant frequency and only one parallel resonant frequency exist, and they can be made equal to the transmission frequency and the local oscillation frequency.

Since a second capacitor element is provided which constitutes a second resonant circuit for at least series resonating between the second switching diode and the ground together with the inductor element for feeding the second switching diode, and the series resonant frequency of the second resonant circuit is set about equal to the frequency of a signal other than the receiving signal input to the receiving circuit.

Since the second resonant circuit is provided between the connection point of the second switching diode and the receiving circuit, and the ground, the second resonant circuit does not affect the transmitting circuit during transmission of signals.

Since the second resonant circuit is formed of a second series-parallel resonant circuit, and the parallel resonant frequency of the second series-parallel resonant circuit is set about equal to the frequency of the receiving signal, the receiving signal is not attenuated.

Since the second capacitor element and the inductor element for feeding the second switching diode are formed of lumped-constant-type circuit components, the resonant frequencies can be set to the receiving frequency, and to the frequency of an interference signal.

What is claimed is:

1. A transmission-and-receiving switching circuit comprising:
a signal input-and-output end to which an antenna is connected;
a transmission circuit connected to the signal input-and-output end through a first switching diode, the transmission circuit configured to output a transmission signal;
a receiving circuit connected to the signal input-and-output end through a second switching diode, the receiving circuit configured to receive a receiving signal; and
inductor elements for feeding bias voltages to the first switching diode and the second switching diode,
wherein the first switching diode and the second switching diode are switched to operating states opposite to each other by the bias voltages, the operating states being on and off;
a first resonant circuit contains a first capacitor element coupled with the inductor element for feeding the first switching diode, the first resonant circuit at least series resonating between the first switching diode and ground; and
a series resonant frequency of the first resonant circuit is about equal to a frequency of a signal other than the transmission signal.

2. The transmission-and-receiving switching circuit of claim 1, wherein the series resonant frequency is about equal to a frequency of a local oscillation signal in the transmission circuit.

3. The transmission-and-receiving switching circuit of claim 1, wherein the first resonant circuit is provided between ground and a connection point of the first switching diode and the transmission circuit.

4. The transmission-and-receiving switching circuit of claim 1, wherein the first resonant circuit is formed of a series-parallel resonant circuit, and a parallel resonant frequency of the series-parallel resonant circuit is about equal to a frequency of the transmission signal.

5. The transmission-and-receiving switching circuit of claim 1, wherein the first capacitor element and the inductor element for feeding the first switching diode are formed of lumped-constant-type circuit components.

6. The transmission-and-receiving switching circuit of claim 1, further comprising a second resonant circuit comprising a second capacitor element coupled with the inductor element for feeding the second switching diode for at least series resonating between the second switching diode and ground, wherein a series resonant frequency of the second resonant circuit is about equal to a frequency of a signal other than the receiving signal.

7. The transmission-and-receiving switching circuit of claim 6, wherein the second resonant circuit is provided between ground and a connection point of the second switching diode and the receiving circuit.

8. The transmission-and-receiving switching circuit of claim 6, wherein the second resonant circuit is formed of a second series-parallel resonant circuit, and a parallel resonant frequency of the second series-parallel resonant circuit is about equal to a frequency of the receiving signal.

9. The transmission-and-receiving switching circuit of claim 6, wherein the second capacitor element and the inductor element for feeding the second switching diode are formed of lumped-constant-type circuit components.

10. A transmission-and-receiving switching circuit comprising:
a pair of signal input-and-output ends, an antenna connected to one of the pair of signal input-and-output ends;
a transmission circuit connected to the one of the pair of signal input-and-output ends through a first switching diode and to the other of the pair of signal input-and-output ends through a second switching diode, the transmission circuit configured to output a transmission signal of a transmission frequency;
a receiving circuit connected to the one of the pair of signal input-and-output ends through a third switching diode and to the other of the pair of signal input-and-output ends through a fourth switching diode, the receiving circuit configured to receive a receiving signal of a receiving frequency;
an inductor element connected between each switching diode and each of a pair of voltage feeding points; and
a first resonant circuit that contains a first capacitor element connected between ground and a first of the inductor elements and a second resonant circuit that contains a second capacitor element connected between ground and a second of the inductor elements;
wherein the first and fourth switching diodes operate in opposite operating states from the second and third switching diodes, and
a series resonant frequency of the first resonant circuit is about equal to a frequency of a signal other than one of the receiving and transmission signals.

11. The transmission-and-receiving switching circuit of claim 10, wherein the series resonant frequency is about equal to a frequency of a local oscillation signal in one of the receiving and transmission circuits.

12. The transmission-and-receiving switching circuit of claim 10, wherein a first connection point connects the first switching diode, the second switching diodes and the transmission circuit, and the first resonant circuit is provided between ground and the first connection point.

13. The transmission-and-receiving switching circuit of claim 12, wherein a second connection point connects the third switching diode, the fourth switching diode and the receiving circuit, and the second resonant circuit is provided between ground and the second connection point.

14. The transmission-and-receiving switching circuit of claim 12, wherein a second connection point connects the first switching diode, the third switching diode and a first of the pair of signal input-and-output ends, and the second resonant circuit is provided between ground and the second connection point.

15. The transmission-and-receiving switching circuit of claim 10, wherein a first connection point connects the third switching diode, the fourth switching diodes and the receiving circuit, and the first resonant circuit is provided between ground and the first connection point.

16. The transmission-and-receiving switching circuit of claim 15, wherein a second connection point connects the first switching diode, the third switching diode and a first of the pair of signal input-and-output ends, and the second resonant circuit is provided between ground and the second connection point.

17. The transmission-and-receiving switching circuit of claim 12, wherein the first resonant circuit is formed of a series-parallel resonant circuit, and a parallel resonant frequency of the series-parallel resonant circuit is about equal to the transmission frequency.

18. The transmission-and-receiving switching circuit of claim 15, wherein the first resonant circuit is formed of a series-parallel resonant circuit, and a parallel resonant frequency of the series-parallel resonant circuit is about equal to the receiving frequency.

19. The transmission-and-receiving switching circuit of claim 13, wherein the first and second resonant circuits each comprise a series-parallel resonant circuit with a parallel resonant frequency of about equal to the receiving frequency and the transmission frequency, respectively.

20. A method of receiving and transmitting signals, the method comprising:
transmitting a transmission signal to a signal input-and-output end through a first switching diode;
receiving a receiving signal from the signal input-and-output end through a second switching diode;
feeding bias voltages to the first switching diode and the second switching diode;
switching the first switching diode and the second switching diode to opposing operating states via the bias voltages; and
coupling a first series resonant circuit between the first switching diode and ground, the first series resonant circuit having a first series resonant frequency about equal to a frequency of a signal other than the transmission signal.

21. The method of claim 20, further comprising forming the first series resonant circuit from an inductor in series with a first capacitor, connecting the first capacitor to ground and the inductor to the first switching diode.

22. The method of claim 21, further comprising forming a parallel resonant circuit with the first series resonant circuit by connecting a second capacitor in parallel with the inductor, the parallel resonant circuit having a frequency of about equal to a frequency of the transmission signal.

23. The method of claim 20, further comprising reducing local oscillation signals when transmitting the transmission signal by providing that the first series resonant frequency is about equal to a frequency of the local oscillation signals.

24. The method of claim 20, further comprising coupling a second resonant circuit between the second switching diode and ground, a second series resonant frequency of the second resonant circuit having a second resonance frequency of about equal to a frequency of a signal other than the receiving signal.

25. The method of claim 24, further comprising forming the second series resonant circuit from an inductor in series with a first capacitor, connecting the first capacitor to ground and the inductor to the second switching diode.

26. The method of claim 25, further comprising forming a parallel resonant circuit with the second series resonant circuit by connecting a second capacitor in parallel with the inductor, the parallel resonant circuit having a frequency of about equal to a frequency of the receiving signal.
